(19) United States
(12) Patent Application Publication
(10) Pub. No.: US 2019/0317123 A1
(43) Pub. Date: Oct. 17, 2019

(54) INTEGRATED CELLULAR TOWER MONITORING SYSTEM

(71) Applicant: Terrance O'Brien Woodbridge, Cary, NC (US)

(72) Inventor: Terrance O'Brien Woodbridge, Cary, NC (US)

(21) Appl. No.: 14/157,775

(22) Filed: Jan. 17, 2014

(51) Int. Cl. G01P 15/18; H04B 17/16; H04B 17/18; H04B 17/10; G06F 21/87

(52) U.S. Cl. CPC G01P 15/18; H04B 17/16; G06F 21/87; H04B 17/104; H04B 17/18

(57) ABSTRACT

A dynamic and expandable communication tower monitoring unit includes a set of programmable modules for returning information about the electrical, environmental, structural, and communications status of a cellular tower, its components and ancillary service and carrier equipment. The monitoring unit processes programmable analog, digital, thermistor, voltage and trending inputs. Key features include an accelerometer-based structural sensor (“twist and sway”), a grounding integrity system for multiple tenants, and a second secure-feedback module (“watchdog circuit”) that provides an extra layer of protection in case of the system-wide electrical and/or communications failure. An operating system provides a series of control screens that allow for remote and local control of input and output variables for each tower.

### BACKGROUND

Cell towers have been in operation for decades but are becoming an even more vital link in the communications infrastructure as wireless, smartphone and tablet usage proliferate. As cell tower owners seek to maximize the use of the towers by increasing the number of devices and tenants on the tower, the operation of each tower becomes more critical. It is desirable to have a means to effectively “monitor” these towers for a variety of reasons.

The use of “conventional means” to determine the operational status of a tower and tenant functionality have been insufficient, inefficient and piecemeal at best especially when it is desirable to be aware of the operational status of a large number of towers in diverse locations. Many aspects of the tower and carrier operations are not able to be monitored using conventional means.

Furthermore, a “one-size-fits all” solution is not useful as the cellular towers are not identical to each other in construction, features, and functions that are to be monitored.

### SUMMARY OF THE INVENTION

The tower monitoring system includes a tower monitoring unit that manages data inputs from various dry, digital and environmental inputs which allows for monitoring of the many facets of cellular tower and tower proximity installed equipment for operation, maintenance, environmental, security and safety purposes. The tower monitoring unit is integrated with components that can capture, monitor, report and in some cases control the status of the diverse operational parameters and devices associated with the cell tower, ground systems and tenant equipment through an integrated controller. This integrated controller features many of the novel aspects of the tower monitoring and controlling system and operates on an inventive proprietary platform that has applications in broader areas. Also needed is a solution for monitoring that can be made efficient regardless of the type of tower.

The tower monitoring system makes use of some of the techniques used in building management technology particularly the monitoring of numerous dependent and independent functions such as; temperature, environmental controls, power management, and security in order to assist in monitoring critical systems and manage tower sites. This gives the tower monitoring system the ability to not only monitor any type of existing technology on a cell tower or at a cell tower site but also control and automate any and all monitoring components.

The tower monitoring unit includes an on-site central processing unit (CPU) which includes an executable module with its own onboard memory and programmable communications port and is installed at each tower site. The onboard memory of the tower monitoring system is segregated for both application support (software) and onboard data logging. In addition, the controller has the capability to run complex algorithms (e.g. to determine remaining run time for a generator based on fuel level). The supporting software (which also allows for third party software to integrate devices) allows access to the site controller and well as logged data. All access is secured and controlled by user level authentication.

Additionally, the CPU and the controller have “smart” inputs, which allow them to be programmed to accept any number of technology applications, inputs and devices. This includes everything from dry contacts to resistance monitoring. The controller also has smart output relays that can be triggered by an input state, a condition, system fault, automated process, software command or any combination of occurrences.

The tower monitoring system implements a software platform that communicates directly to the onsite controllers via a secure tunnel. The communications path to local and network controlling and monitoring stations can be supported by internet, cellular, fiber, copper lines, and/or microwave making it secure, reliable and flexible.

The tower monitoring system includes an on-site controller module which has its own built-in memory and database, giving it the ability to operate in a stand-alone state as well as to log on-tower site data. In addition, the controller has the ability to run automated commands based on events, calendar, actions and/or inputs.

All input points to the controller are generally universal and are software configurable (and include the ability to run third-party software for input and output devices that require it). They can be programmed as analog, voltage, thermistor, digital, counter point types, etc. Each controller can accommodate up to 256 inputs, all universal and all software configurable.

All output relays are Form C relays. All outputs are universal and are software configurable. Output actions can be based on events or series of events, clock, calendar, manual control, input state, and automated function.

The approach of the tower monitoring system includes that the monitoring is generally contained in, and performed by, a dynamic (expandable and contractible) single monitoring control unit, an all-tower-and-user-function monitoring system in which all the functions of the tower and related functions and equipment are monitored by the tower monitoring system including: tower lights, intrusion alarms, tamper switches, generator temperature, critical equipment temperature, battery cooling, enclosure temperature, and fire detection. Also included are utility power monitoring, power usage, battery status, and generator status monitoring. The tower monitoring unit also detects standby generator fuel level and monitors tower twist and sway movement.

The tower monitoring unit is also capable of monitoring the presence of certain related operational aspects of all cell tower tenants. These functions include but are not limited to: carrier subsystems, backhaul status, backup battery voltage, backup battery box temperature, microwave operation, carrier equipment ground integrity monitoring, cell radio operational status, directional accuracy of cell antenna placement and movement, carrier equipment tampering or removal.

The tower monitoring unit can be enclosed in one unit in a preferred embodiment and is fully integrated and upgradeable on-site and while in operation from headquarters or remote commands. The tower monitoring system in all embodiments requires only simple installation.

The tower monitoring system allows a single economical unit to effectively monitor many different kinds of towers. Thus, a tower requiring a great deal of monitoring capacity can use the same unit as a tower requiring less complex monitoring needs. Monitoring architecture is able to be used at any cell tower location and in any user data center. Moreover, the same system can be used to monitor so-called Distributed Antenna Systems and Small Cell deployments both independently and in conjunction with related cell tower operations.

The tower monitoring system allows the tower monitoring unit to be networked via a variety of wide area networks and with other tower monitoring units and a variety of control centers.

The tower monitoring system also includes a self-monitoring system. The “watchdog element” of the tower control center is a device that is embedded in the tower monitoring unit. The watchdog element has its own secure path of communications to the network operations center. This path is different and independent of that of the onsite controller. The watchdog element monitors critical aspects of the on-site controller as well as some critical subsystems of the tower and carrier equipment. If a critical situation occurs, i.e., full loss of site communication or malfunction within the controller, the watchdog element will report an alarm condition to the network operations center. This allows remote access to the on-site system in order to identify problems and dispatch the appropriate personnel, saving time, money, and minimizing downtime.

Furthermore, the tower monitoring unit is designed with the unique capability to verify the correct operation of tower and equipment grounding. The system also measures the “ground impedance”, or the ability of the grounding system to effectively dissipate the electrical energy of a lightning strike to ground. The system can also detect loose or absent devices or carrier ground connections including presence/absence of any grounding bar and notify the user.

The tower monitoring system is also able to measure and report the structural integrity, movement, and relative stability of a cell tower. Once a tower is built it needs to be sturdy and to stay aligned. A so-called “twist and sway” sensor in the form of a dual accelerometer with XY orientation is placed in an all-weather housing and, by using a specially designed bracket, is placed at a scientifically determined location or multiple locations on the cell tower and connected by coaxial cable to the tower monitoring system. The tower monitoring system contains a microprocessor and proprietary software algorithms that allow the system to set certain movement and resonant frequency parameters. By comparing these frequencies to a stable resonant frequency of the tower, the system is able to detect and measure motion within the tower. In addition, the system allows for fine tuning and adjustment in order to eliminate false readings. This is done by controlling the attack (the introduction of a timed delay before signal) and decay time (the introduction of a timed delay after the signal). This element of the tower monitoring system provides data on the movement of the tower and allows related structural integrity and functionality calculations to be carried out and utilized. This helps to determine a baseline for equipment loading as well as wind or ice loading of the tower. It also enables the system to detect climbers on the tower and other events.

### BRIEF DESCRIPTION OF THE DRAWINGS

In describing the tower monitoring system, please refer to the following figures in which:

FIGS. 1A and 1B illustrate a sample tower with typical tower equipment.

FIG. 1C is a schematic of cell tower infrastructure.

FIG. 2 is a schematic of the tower monitoring architecture in a multiple tower setting.

FIG. 3 is a module connection chart.

FIG. 4 is a functional schematic of the activation of some of the tower monitoring unit modules.

FIGS. 5A-1, 5A-2, and 5-B are schematic drawings of the microcontroller and the driver circuit. In particular, FIGS. 5A-1 and 5A-2 are schematic drawings of the microcontroller, while FIG. 5B is a schematic drawing of the driver circuit.

FIG. 6A illustrates details of the twist and sway monitoring system as placed on a tower.

FIG. 6B illustrates a sample graphic user interface (GUI) of the twist and sway monitoring system.

FIG. 7 illustrates an overview of the grounding monitoring circuit.

FIG. 8 illustrates an alternate view of multiple carrier grounding monitoring systems.

FIG. 9 illustrates a schematic of the watchdog circuit.

FIG. 10 illustrates a sample schematic of a network operations center (NOC) for monitoring towers.

FIG. 11 illustrates a sample site operation control screen (with a system alarm).

FIG. 12 illustrates a sample site 10 operation control screen.

FIG. 13 illustrates an input setup screen.

FIG. 14 illustrates a security motion detection screen.

### DETAILED DESCRIPTION OF THE DRAWINGS

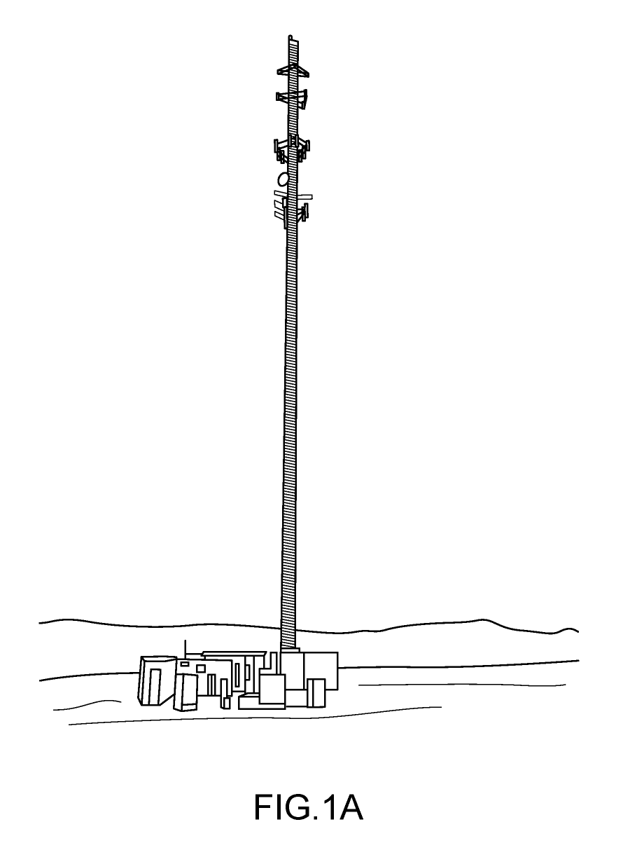

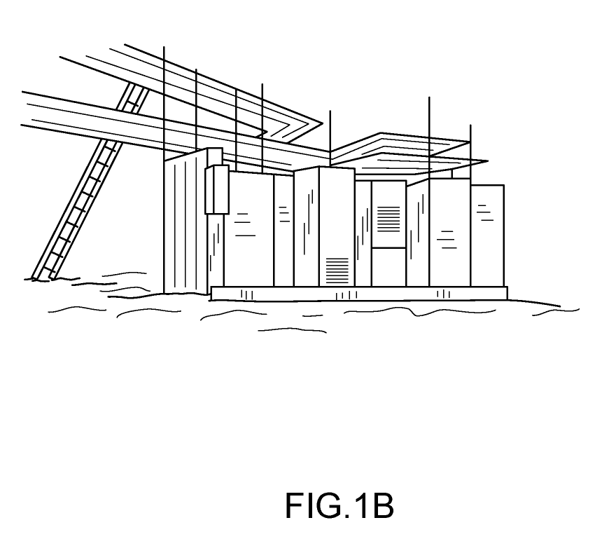

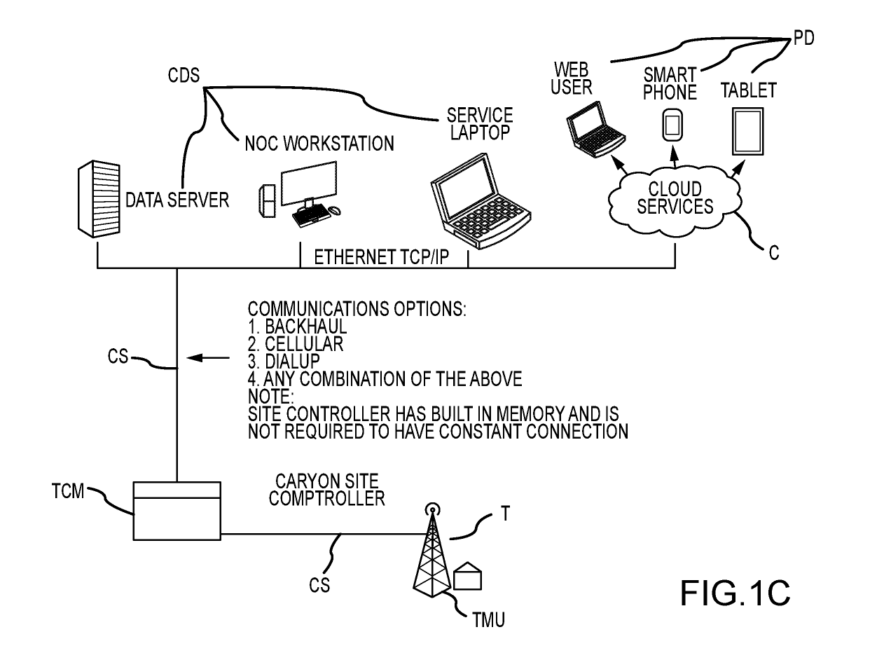

FIGS. 1A and 1B illustrate a sample cell tower and its components.

Referring now to FIG. 1C, an overview of the tower monitoring system architecture is illustrated. A tower T is monitored by a tower monitoring unit (TMU) which is connected via any number of communication means CS, whether locally or through a wide or local network to a Tower Control Module. The Tower Control Module may be local to the TMU, but also may be part of another Tower Monitoring Unit at another location. The Tower Control Module is connected through similar communication means CS to a wide area network that links the Monitoring Unit to any number of viewing, storage and monitoring devices CDS. The communication may take place through “backhaul” (locally connected T1/T3 capacity from/into the tower communication transmission), cellular (such as an aircard), dial-up or any combination of these. The monitoring devices are generally accessed via TCP/IP protocol and may be also accessed by personal devices that have secure access to a “cloud” computing platform. Thus, the tower monitoring unit may be accessed any number of (iterative) ways, in order to ensure that during a communication failure, the tower information (and control) may be accessed.

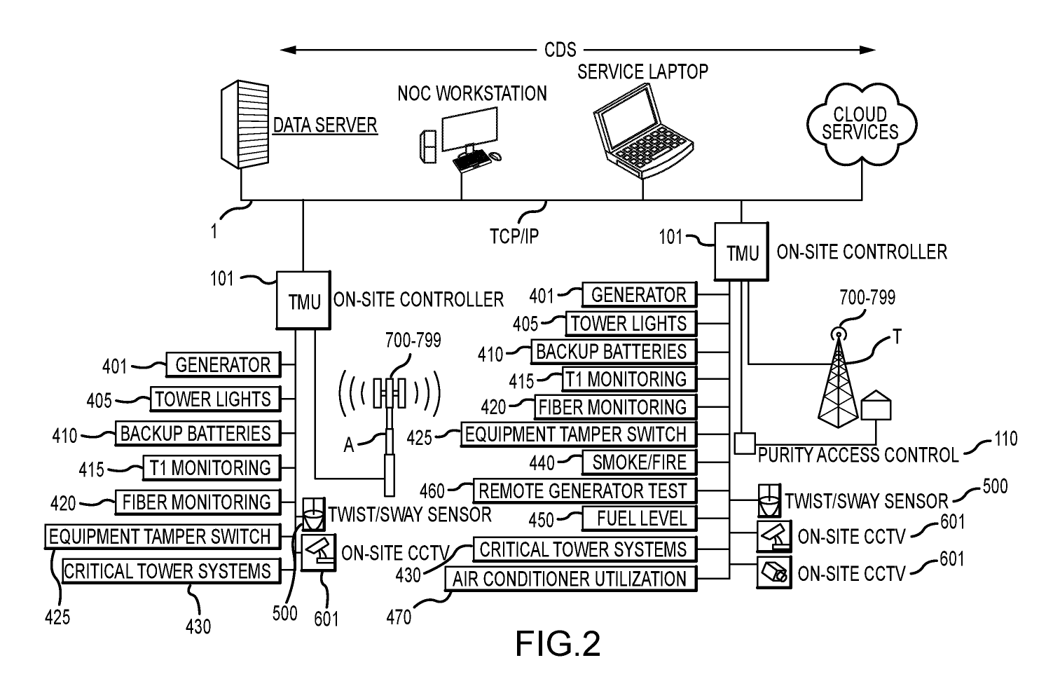

Referring now to FIG. 2, illustrated is a tower control system 100 includes two tower monitoring units (TMU) 101 and 101′ for two different towers (A and B). The tower monitoring units (TMU) 101/101′ are dynamic (expandable and contractible) computational devices preferably contained in a single enclosure that can protect and monitor all the critical and peripheral functions of the tower, even when the tower includes multiple tenants. The tower monitoring units (TMU) include various control modules 400-499, 500-599 and 600-699 (discussed below) that can be implemented either as virtual units or dedicated circuits. In a preferred embodiment, some of the control modules 400-499 are implemented as both software and hardware components, but need not necessarily be either. The control and monitoring modules 400-699 are connected to the tower monitoring units via various inputs and outputs 700-799 detailed below.

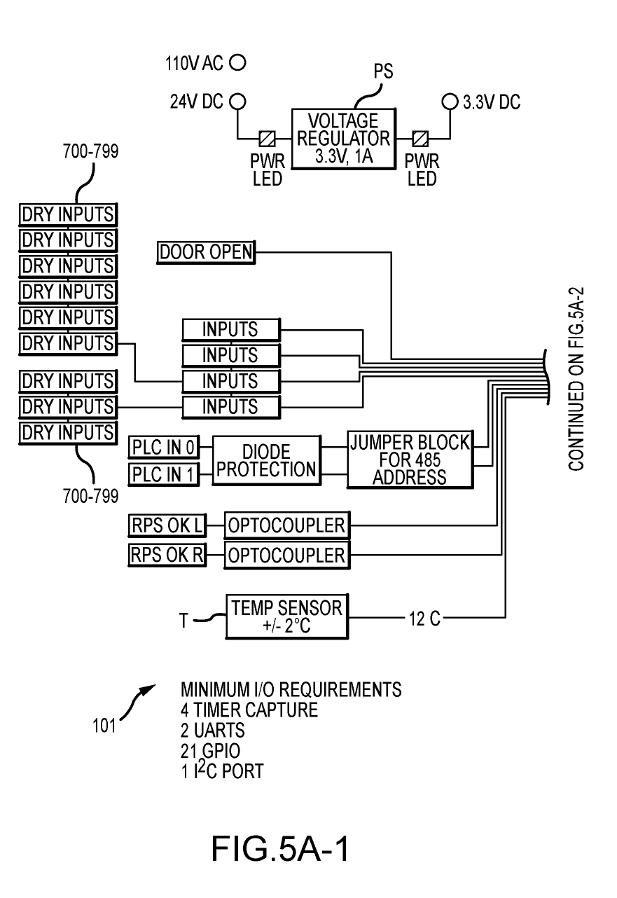

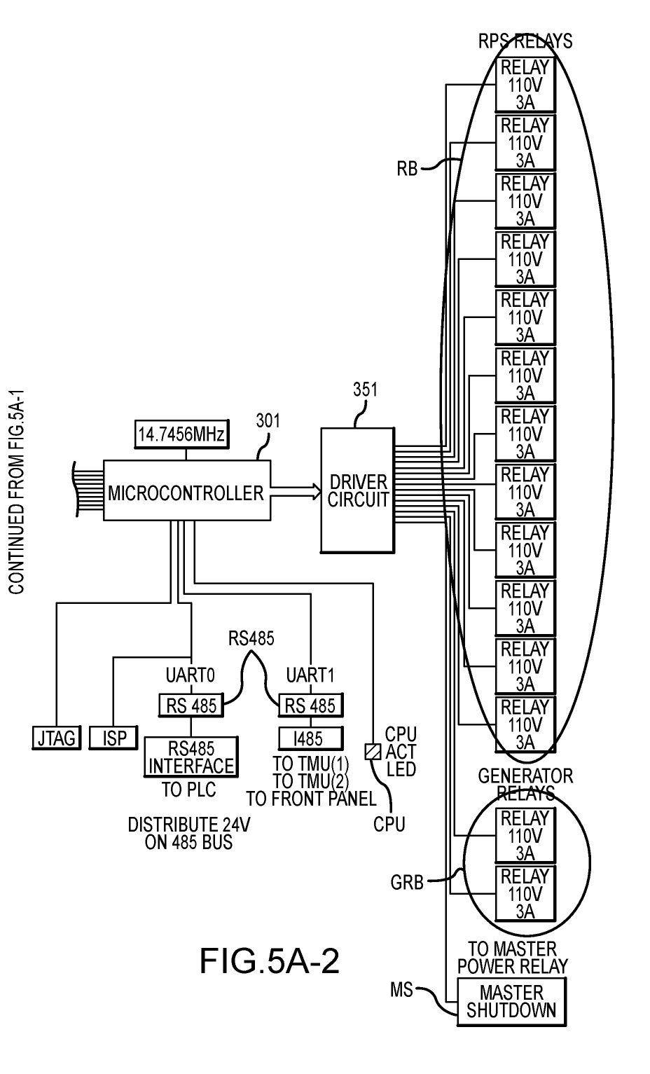

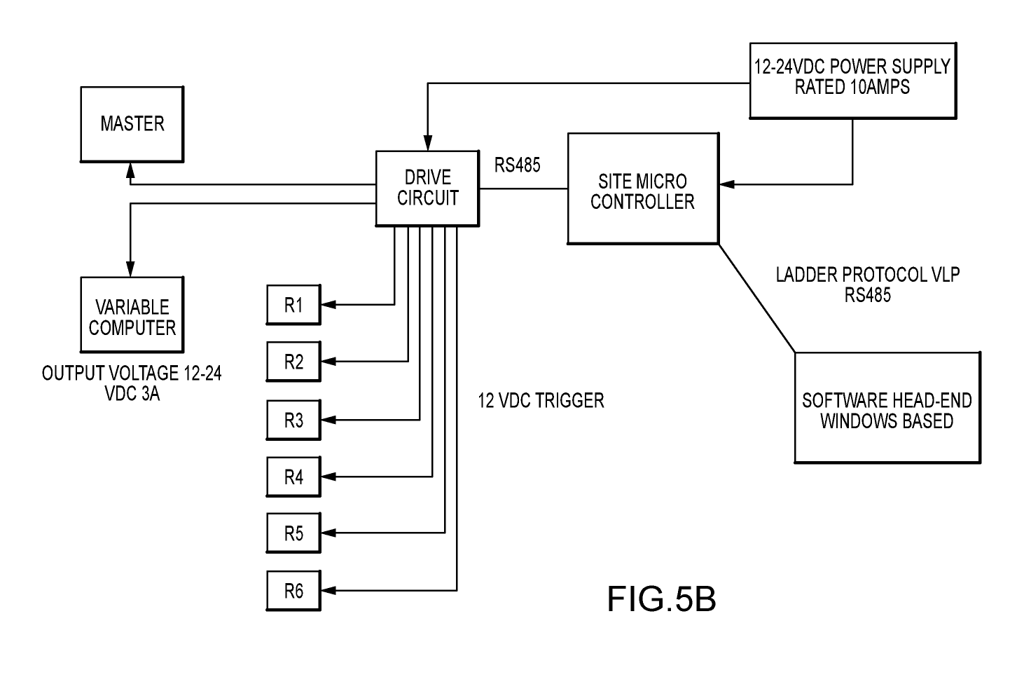

All of these features are implemented into and/or connected to the tower monitoring unit (TMU) (see FIGS. 5A-1, 5A-2, and 5B below). The inventive tower monitoring architecture allows for wide area monitoring and access of multiple towers and tenants. The illustration shown in FIG. 2 includes a sample of two towers A and B (in reality there will be any number of towers monitored at the same time and grouped by various methods, including traffic, importance, hubs, etc.). The towers are each monitored by a versatile, expandable tower monitoring unit (101, 101′). Because each tower is potentially different and may require different monitoring needs, the inventive tower monitoring unit is built to handle various environmental, safety, telecommunication monitor, and structural inputs.

Once again referring to FIG. 2, the control modules in the tower monitoring unit include the following features:

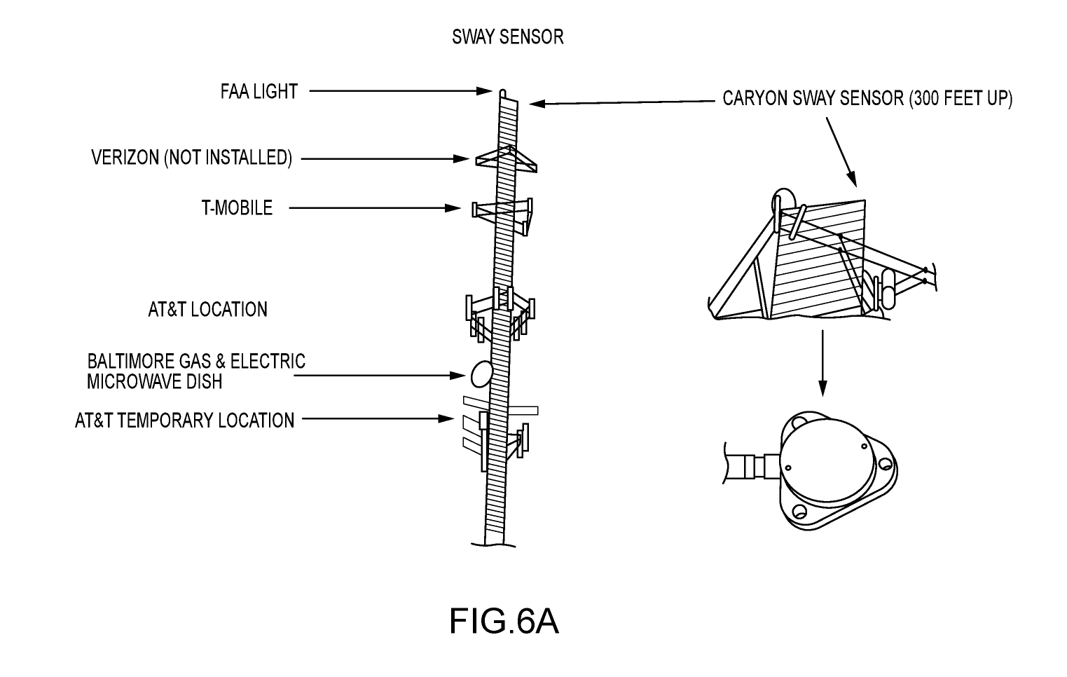

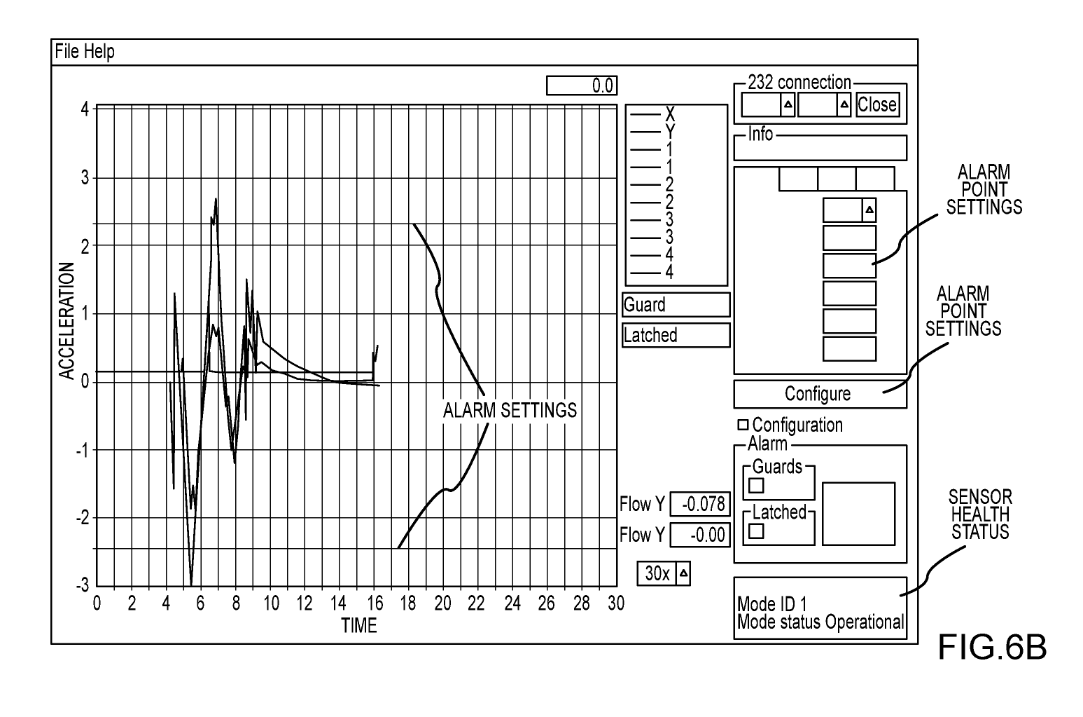

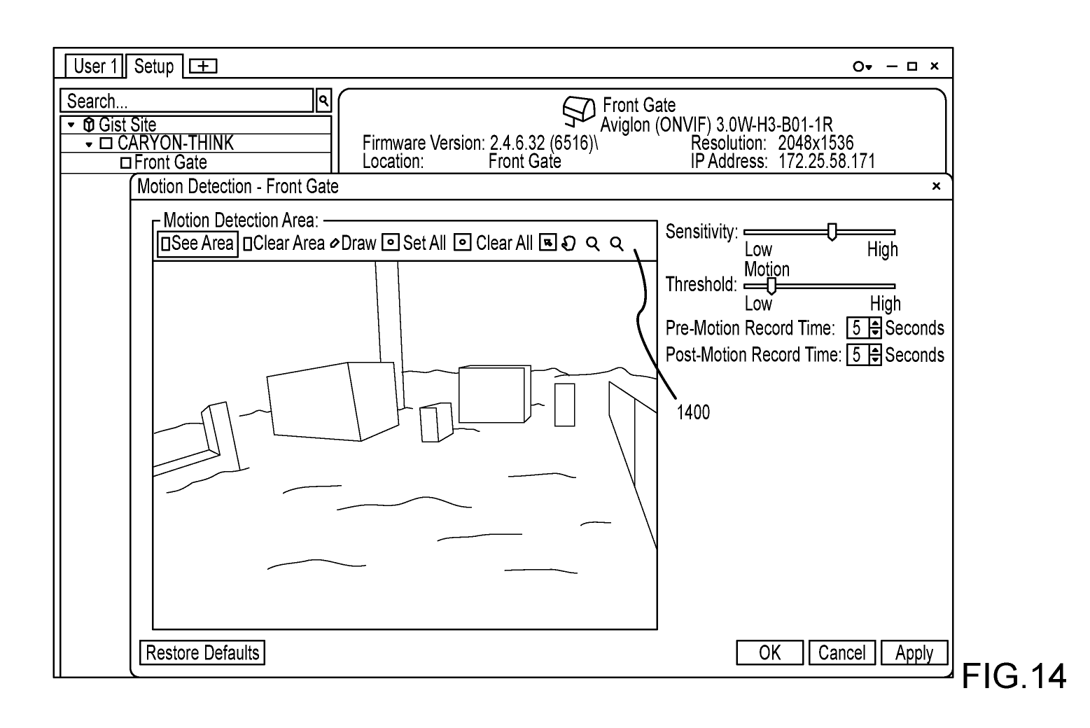

TABLE 1.1
Monitoring modules of the tower monitoring unit

| | | Connection to |
|---|---|---|
| Feature/Module | Index | microcontroller/notes |
| Backup batteries | 410/410′ | Analog input 710/710′ |
| Fire/smoke for generator | 440′ | Analog input 740′ |
| On site cameras | 601/601′ | Digital input |
| | 602 | (see FIG. 14) |
| Fuel level | 450′ | Analog input 750 |
| Access control (optional) | 110′ | See below |
| T1 monitoring | 415′ | Digital input. |
| Fiber monitoring | 420/420′ | See below |
| Remote generator test (if equipped) | 460′ | See below |
| Equipment tamper switch | 425/425′ | See below |
| Carrier systems (all carriers | | See below. |
| on tower functionality) | | |
| Tower communications systems | | See below |
| Twist and sway monitoring (SISS) | 500/500′ | See description below |
| | | in FIG. 6. |
| Air conditioner utilization | 470′ | See description below |
| Utility power monitoring | n/a | |
| (not shown) | | |
| Standby generator monitoring | n/a | |
| (not shown). | | |
| Temperature measurement | 410 | Thermistor/Digital |
| (not shown) which generally | | input 610′ |
| requires a thermistor connected | | |
| to the TMU through a single | | |
| digital input. | | |
| Intrusion alarming system | | Single analog input |
| Tower signal light alerts | 405 | Single analog input 705 |

The tower monitoring system is generally designed for multiple tenants/carriers, as well as a “watchdog circuit” (which is discussed below).

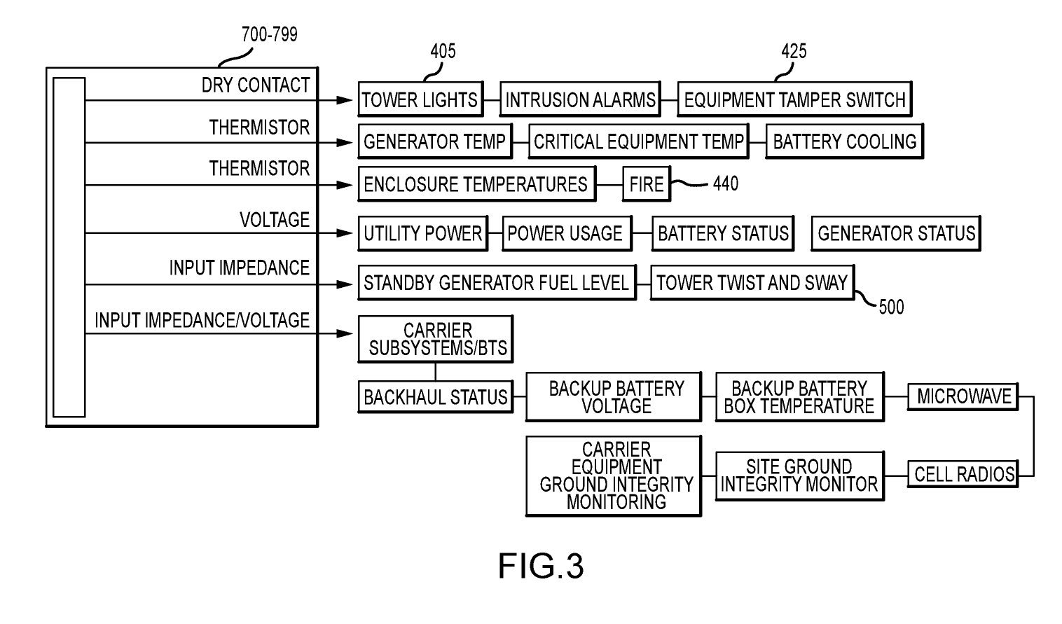

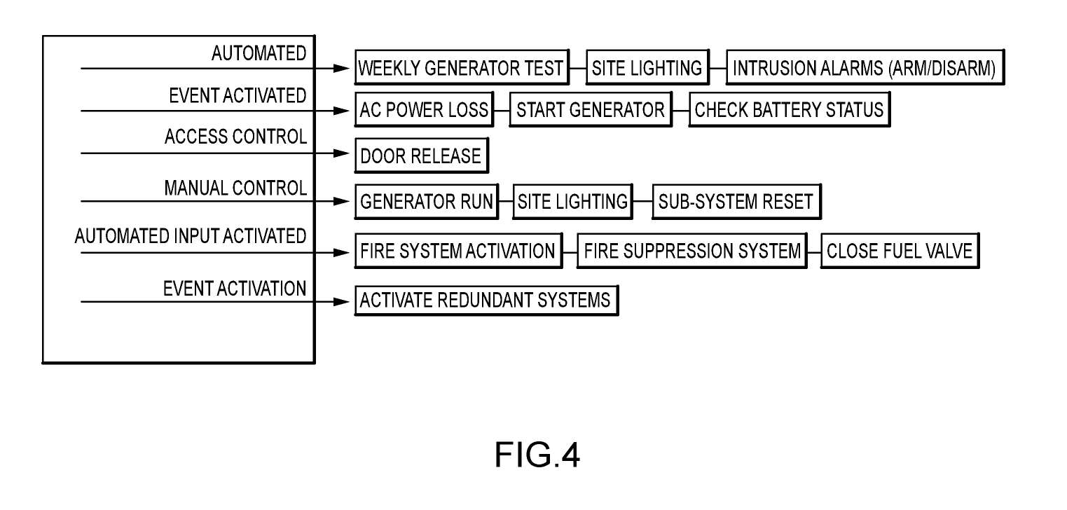

Referring now to FIG. 3, a sample of the output monitoring and the types of contacts is diagrammed. All output relays are Form C relays. All outputs are universal and are software configurable. Output actions, which are shown in FIG. 4, can be based on events or series of events, clock, calendar, manual control, input state and automated functions.

TABLE 1.2
(see also FIG. 4)
Sample modules/functions and activation types in particular embodiments

| Module | Index | Activation type |
|---|---|---|
| Weekly generator test | | Automated |
| Site lighting | | Automated |
| Intrusion alarms | | Automated |
| (arm/disarm) | | |
| AC power loss | | Event Activated |
| Start Generator | | Event Activated |
| Check Battery Status | | Event Activated |
| Door release | | Access control |
| Generator Manual start | | Manual control (remote control) |
| Site lighting | | Automated |
| Sub-system reset | | Manual control |
| Fire System Activation | | Automated input activated |
| Fire Suppression System | | Automated input activated |
| Close Fuel Valve | | Automated or manual |
| | | input activated |
| Activate redundant systems | | Event activation |

The above table is not comprehensive, nor limiting, but rather seeks to illustrate how modules may be programmed to be activated by the microcontroller in particular embodiments (the dynamic and expandable/contractible programming modules are discussed below). In general, the tower monitoring system can monitor a variety and quantity of different towers with different end-use needs, by employing the various modules and using the similar inputs. However, as discussed below, controls can be also be easily reprogrammed with minor effort as an additional advantage of the present tower monitoring system.

Referring now to FIGS. 5A-1, 5A-2, and 5B, the tower monitoring unit (TMU) 101 (see FIGS. 5A-1 and 5A-2) is generally expandable to 99 input ports if needed. The tower monitoring control unit is one embodiment of the system as it can be seen as an integrated and dynamic solution. In general, the microcontroller operates a CPU (not shown) such that all the modules listed in FIGS. 2-4 and 6A-10 monitor the activities of the tower.

Referring now to FIGS. 6A-6B, a twist and sway tower information system as part of the tower monitoring unit is illustrated. A vital piece of information regarding a tower that is integrated into the systems or may be deployed as a stand-alone system is the “twist and sway” monitoring part of a primary embodiment. Twist and sway tower structural integrity is vital to the functioning of the tower. Towers can be lattice towers, guy wire towers, monopoles and so-called “stealth monopoles” as well as broadcast towers, civil defense towers, etc. Some towers are more susceptible to “twist and sway” based on structure type, height, footprint, local wind, and other environmental conditions as well as equipment overloading. In many cases towers have microwave dishes located on them. Microwave dishes are “gain dependent and have a narrow broadcast path (beam).” The better the focus of the microwave beam the higher the gain for that dish. The microwave dish achieves its “gain” by focusing the majority of its radiated energy into a single, highly-focused beam. Having a tower twist or sway will decrease the focus of the beam and in turn lowers the gain (power) of the broadcast. By monitoring the twist and sway, the twist and sway monitoring module gives the end-user the ability to identify a small problem before it becomes a big one whether it is microwave dish movement or a problem with the structural integrity of the tower. In addition, the twist and sway system can help identify whether the problem is with the receiving dish or the transmitting dish. This is very critical information when an end user is trying to identify where the problem is located. The twist and sway system can also be tuned to detect activity on the tower and in that regard serves as a security and usage monitor.

The present invention includes a feature that has the capability of not only monitoring the structural integrity but also monitoring the actual “twist and sway” of a tower. The structural integrity sensor system is a state of the art, all-weather technology that can detect “twist and sway” with a high degree of accuracy as well as structural problems like stress cracks and any other structural deficiencies. Referring now to FIG. 6A, a structural integrity system is illustrated. The tower monitoring system is able to measure and report the structural integrity, movement, and relative stability of a cell tower. Once a tower is built it needs to be sturdy and to stay aligned. A so-called “twist and sway sensor” in the form of a (at least) one dual accelerometer with XY orientation is placed in an all-weather housing and by using a specially designed bracket is placed at a scientifically determined location or multiple locations on the cell tower and connected by coaxial cable to the tower monitoring system. The tower monitoring system contains a microprocessor and software algorithms that allows the system to set certain movement and resonant frequency parameters. By comparing these frequencies to a stable resident frequency of the tower the system is able to detect and measure motion within the tower. In addition, the system allows adjustment for non-recurring events or anticipated events by creating so-called “attack and decay” set points to eliminate false alarms. This element of the tower monitoring system provides data on the movement of the tower and allows related structural integrity and functionality calculations to be carried on and utilized.

The structural integrity sensor system 500 is integrated into the tower monitoring unit 101 The sensor system includes a specialized accelerometer unit 502 placed at a strategic location on the tower depending on tower type, tower materials, weld points, tower segments, height, and desired monitoring and transmits changes in the x direction and changes in the y direction (assuming that in a preferred embodiment that changes in z direction are not needed). Threshold changes in either direction provide signals to inputs (715, 716) (which are general digital, but can be analog depending on the endues implementation) that are processed in the Tower Monitoring Unit 101 with software that can be adjusted and modified to input the configuration of the accelerometer that allows for efficient monitoring of structural changes in the tower. In addition, the structural integrity sensor system 500 has a wireless communication transmission system 532 that allows it to communicate with the SISS module, even in the event of a total communication blackout. The wireless communication transmission “broadcasts” 531 from the accelerometers to a “receiver” on the TMU 101. Thus, even though there may be damage to the communication and/or power systems, information on the twist and sway of the tower and/or the structural integrity of the tower can be acquired by the TMU 101.

An end-user can also use the SISS to gather raw data regarding the x and y movements of the tower, as the specialized accelerometer unit 502 can also provide raw digital data for analysis by the end-user. In such a case, data is processed and loaded into storage (not shown) via raw digital inputs 517, 518. The data can later be downloaded via a network.

The structural all-weather sensor can be mounted to any surface. By measuring acceleration simultaneously in two directions (X and Y), the SSIS is able to accurately detect, measure, and capture data on tower twist and sway. In addition, the accelerometer sensors have the ability to monitor the structural integrity of a tower by detecting and comparing tower harmonic frequencies. Stress cracks, broken welds, and stressed metal all generate a unique frequency during movement. Climbing on the tower or the addition or removal of equipment from the tower can also be detected in the same fashion.

A key feature of the SISS also may include the ability to function as a standalone device. In general, the SISS functions as an included sensor system within the full enduser critical monitoring system. The SISS has the ability to run multiple sensors on a single tower. The XY Sensor is only component attached to the tower and thus generates a great deal of important information from a single sensor. The SISS sensor is made of all-weather stainless steel construction, and is connected to the TMU through a single CAT5 cable. The SISS includes full remote data logging ability and aggregation for further analysis. An optional feature allows real-time review of live data remotely and has the ability to trigger automated response within the monitoring system.

Referring now to FIG. 6C, a sample twist-and-sway sensor screenshot is shown. Different configurations are possible to display movement of the tower (or other valuable equipment) in the X and Y directions. As shown, the X and Y movements are shown in green and blue and the threshold for an alarm/alert is also shown. The panel(s) at the right allow for adjustments to the parameters and the status of the sensor(s).

The twist and sway system is implemented with accelerometers in a preferred embodiment. However, certain end-use needs may also allow for the use of gyroscopes, interferometers, and even GPS programs that run either independently or in addition to the accelerometer-based systems. Also, the addition of weather detection equipment, such as an anemometer may add to the efficiency and accuracy of the twist and sway monitoring. Also, additional devices (such as an accelerometer) may be added to provide three-dimensional monitoring depending on the end-use needs.

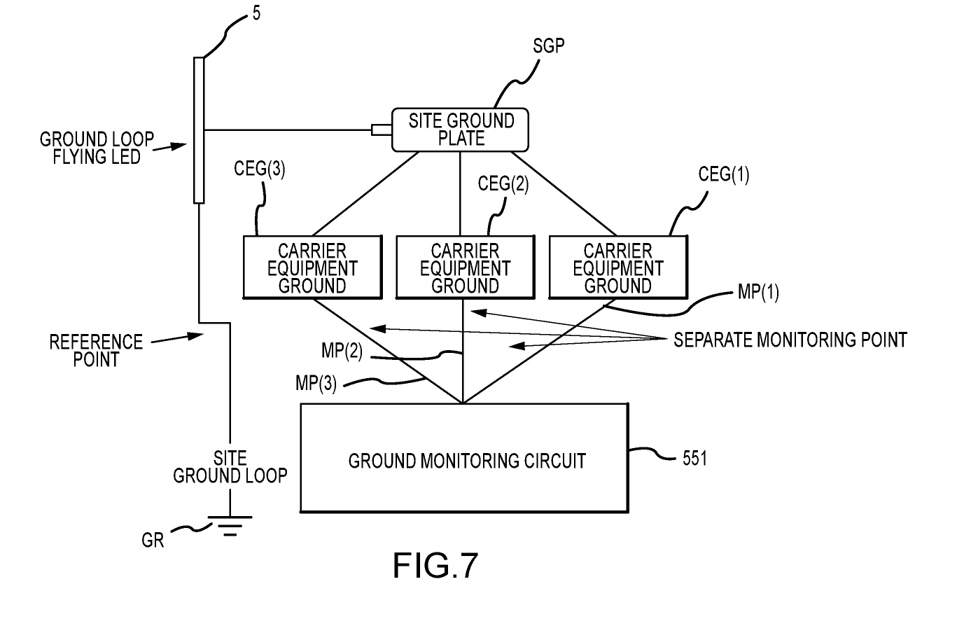

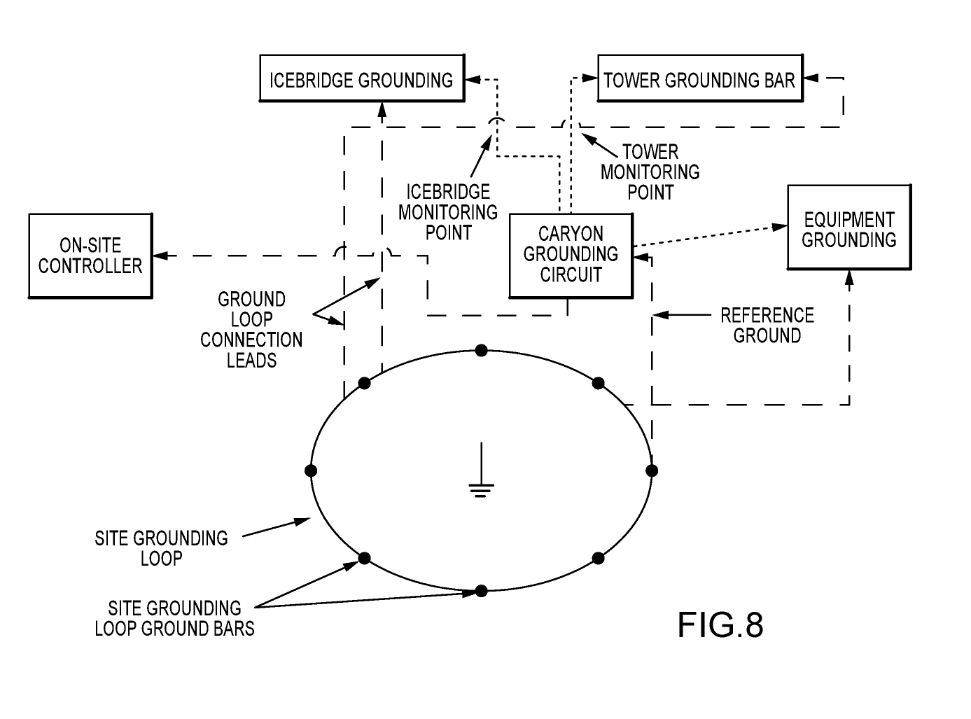

Now referring to FIGS. 7 and 8, a ground monitoring circuit schematic is illustrated. FIG. 7 illustrates a ground monitoring circuit from a high level. A Reference Plate/point RP is operatively connected to a site ground plate SGP. In turn, the site ground plate SGP is connected to the various (multiple) carrier ground equipment CEG(1 . . . 3). The various carrier ground equipment is connected to the ground monitoring circuit 551′ at the separate monitoring points MP(1 . . . 3). The ground monitoring circuit 551′ is also connected to the reference point to determine the status and health of each carrier's grounding systems.

Referring now to FIG. 8, a sample type of grounding reference system that may be implemented is shown for an “ice bridge” and other feature for the various carrier grounding safety systems as shown in FIG. 7.

The tower monitoring unit includes a CPU that executes stored instructions that generally take the form of a proprietary software platform on which the tower monitoring system can be operated. However, it is anticipated that a combination of back end/front end software operations may allow for simple operation of the entire TMU. While alternate and/or additional embodiments allow the platform to be operated virtually through networks, in a preferred embodiment, the operating system is self-contained in the TMU. There are many “programmable elements” to the modules of the tower monitoring unit, which includes features such as: Microsoft SOL Express Support, both digital and analog inputs monitoring, searchable database, and site by site ID (depending on the needs of the end user).

One of the advantages of the current tower control and monitoring system is that it is dynamic and allows for “iterations” of control from several different levels. This includes local control, control at the intermediate level (or substation) and fully centralized control. This is generally achieved using a Web Client for anywhere access to software which is generally password controlled, but need not been limited to such due to the nature of emergency monitoring. This is represented in FIG. 1, discussed above.

An optional local video monitor(s) allows for local control that is built into the TMU. The local video monitor(s) may be a local attachment, and not permanently attached on site. However, as the TMU is designed to be accessed through any number of dedicated or portable devices, a local monitor will generally not be needed by a service technician, except in the event of a catastrophic communications failure.

Another feature of the system provides a secure environment and also allows for customizable access. Thus, local, substation, and central control can all have different levels of control and data access. The system may be operated as a “Stand Alone” operation for onsite commission and service. An on-site technician may simply enable the device and allow a person with remote access to verify that all systems are operating properly or the on-site technician may be equipped with a laptop computer or tablet that allows access to the system and enables the technician to verify functionality and correct operating parameters.

The system also allows for “full data” logging that is customizable whether the data is culled from the processed data (like the twist and sway processed data as discussed above, which is integrated by software running in the TMU for determining important twist and sway events) or from raw digital data (which may require using additional unassigned inputs in the tower monitoring unit depending on the data desired by the end user).

The system expects that there will be multiple users with password control levels. Access levels and the related data that can be observed and actions that can be taken based on access location and pre-determined access levels will be established and controlled as requested by the tower company or carrier for which functionality is monitored using various security software packages which integrate seamlessly into the tower monitoring system. The TMU will track “user login data logging” and have “access control capabilities” (as discussed above). Site data records and access records will be stored either in an on-site CPU, in the deployed device module where such storage is available, or remotely at designated locations using commercially available data storage devices. This data may be retained long term or deleted based on user parameters

In general, the tower monitoring unit (TMU) will be enclosed in an enclosure that is in a NEMA 4 (the specifications of which are incorporated by reference herein for such purposes) or better enclosure. The system is constructed with the ability to monitor the maximum amount of monitoring points for a single tower, carriers and related nodes which may include small cells and distributed antenna systems can provide. With this capacity, one TMU per tower will provide all field monitoring needs. This will help control cost by having one standardized box instead of several, and also allowing personnel to install and service one device and adjusting one device and activating (or deactivating) monitoring modules as the end use needs change.

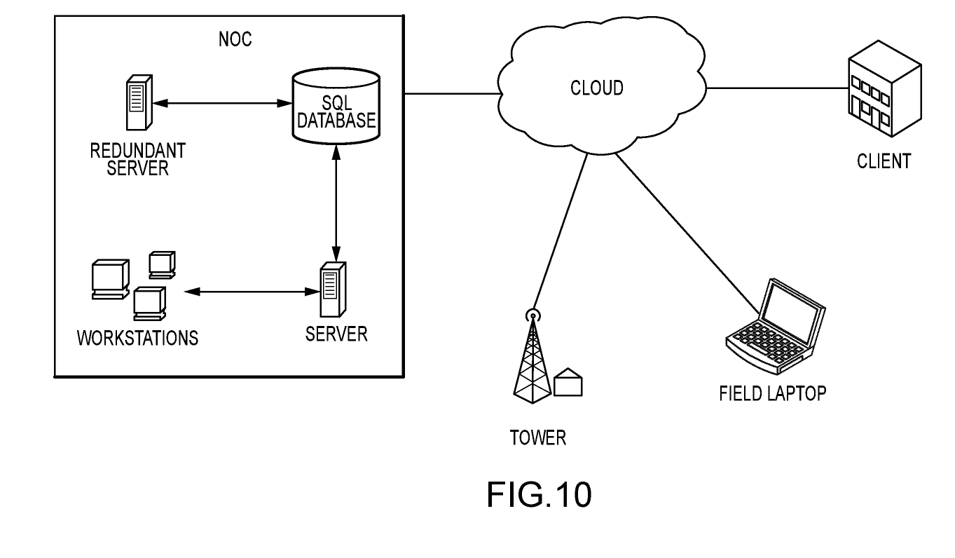

Additionally, in particular embodiments, the TMU houses at least one 7 amp hour battery for momentary backup until an on-site generator (if available) comes online or emergency personnel can be dispatched for repairs. The enclosure also has communications ports for network operations center (NOC) (see discussion below in FIG. 10) access.

The TMU will include a communications port for cell backup in case a main method of communication (usually T1/T3 backhaul) becomes inoperative. The TMU will also generally include multiple knockouts for external wiring, which meets NEMA 4 or better requirements (As stated above, the NEMA 4 standards are hereby incorporated by reference). Other features include: a weather resistant connection point, a high security enclosure lock, external mounting system (for easy on mounting and to meet a NEMA 4 or better rating), and an enclosure tamper switch.

In a preferred embodiment, the tower monitoring unit (TMU) includes two main internal components and many computational (virtual) components in the form of monitoring modules (discussed above). The two main components are the tower microcomputer which can be implemented as two hardwired circuits (a TMU microcontroller and a TMU driver circuit). These internal circuits/devices, (which may include independent circuitry) can used to monitor all internal functions.

The Tower Monitoring Unit also includes optional features.
a. For example, the tower monitoring system can include a cellular backup unit (aircard) in the event there is a lost broadband connection.
b. The TMU can be connected to two 6 amp hour batteries for extended run time.
c. The TMU may include internal heat sinks for efficient heat transfer without the use of additional power.
d. The TMU may include an external test port for on-site testing of unit.
e. The TMU may include optional internal LED lighting.
f. There can also be a video monitoring unit with stand-alone unit with a monitoring point.

In general, there are various ways to set up and operate a related data center without departing from the scope of the invention. Below are a few suggested steps that allow the tower monitoring system to be implemented in a first embodiment. The steps include:
(1) Have site information preloaded at the data center 805.
(2) At site enclosure mounted and powered 810.
(3) Call into data center 812 and have them bring the controller online 815. [Note: on-site technicians should be making all the proper contact connections at this time in order to maximize his or her time 899].
(4) Data center calls technician to confirm that the controller is online and ready for testing 820. [Note: this process takes only minutes to perform].
(5) On site technician will run site test 850-870. Testing order is as follows:
   (a) Test the proprietary monitoring circuit
   (b) Run through all contact points
   (c) Run through any and all intrusion points
   (d) Test FAA lighting
   (e) Generator on test
   (f) Generator fail test
   (g) AC fail test
   (h) Remote generator start test
   (i) Fuel level test
   (j) Backhaul failure
   (k) T1/T3 failure
   (l) Dark fiber test
   (m) Radio failure (if included)
   (n) Datapack failure (if included)
   (o) Equipment tamper
   (p) twist and sway operation

Referring now to FIG. 10, in certain embodiments, the tower monitoring system will include a state of the art network operations center NOC, which may be implemented in different embodiments. This center will be highly scalable and adaptable based on demand. The features of the NOC include, but are not limited to:
a. Full server arrays
b. Customized monitoring software including real-time monitoring of cell tower critical systems.
c. Server interface devices designed for effective connect to tower field units (TMU).
d. UPS to support loss of utilities.
e. Broadband connection specified competitively and consisting of:
   a. Fiber.
   b. Multiple T1 's, T-3 or greater with bandwidth optimization and back up.

Other (optional) features of the NOC element of the tower monitoring system may include: (1) an interactive operations manual for the NOC with help desk functionality, (2) interactive and modular training program development for NOC personnel, (3) cell backup system to allow for connections to critical towers during loss of broadband service; (4) redundant server systems and loss prevention architecture; and (5) cloud storage for archived data and functional backup including procurement, management tools, and monitoring.

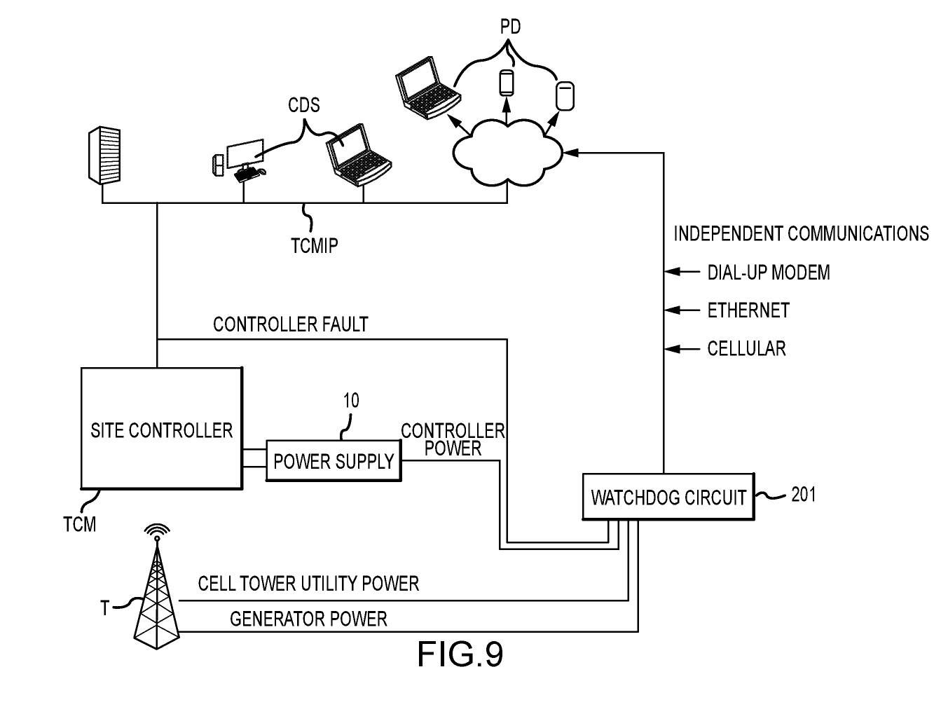

Another powerful feature of the tower monitoring system in a primary embodiment is the “stand-alone self-monitoring system” (SAMS) or watchdog system (Illustrated in FIG. 9). The SAMS control module is an independent sub-system that monitors the primary functions of the monitoring on-site controller (TMU) and the connected support systems. The SAMS system currently has the ability to monitor 16 inputs and activate 4 outputs and is expandable. It can use an Ethernet LAN interface for communications or a modem and operates with security protocols including Internet Protocol Security (IPSec) and Secure Socket Layer (SSL). When a supporting system like the primary lines of communication to a tower are down, all communication to that tower including the monitoring systems may fail. In many cases multiple service personnel would need to be sent to fix the unknown problem(s), which costs money and increases the down time of the tower. The SAMS feature of the system allows a user to login through a security feature to the SAMS and allows the user to identify the problem and cause. This feature gives an authorized system user the ability to dispatch the properly trained personnel to the site to fix the identified problem saving time, money and limiting downtime.

This SAMS “watchdog element” of the tower control center can be embedded in the tower monitoring unit or separately housed, and monitors critical aspects of the onsite controller as well as some critical subsystems of the tower and carrier equipment. In a preferred embodiment, the “watchdog” system has the ability to monitor 16 inputs and activate 4 outputs. The watchdog element contains its own power source and means of communications to monitor the primary support systems to the tower and the status of the on-site controller.

Other embodiments of the tower monitoring system implement various configurations of equipment in order to serve the needs of a single or multiple end users. In a first example, rather than monitoring dry contact outputs on a battery backup system to detect a fault, the system will be configured to alert the customer when the system being monitored reaches a certain threshold of charge. In a second example, in case of loss of AC power to the site, the system can sustain generator operations until the utilities to the tower have stabilized. This will eliminate the risk of damaged equipment due to brownouts or power surges that are common in remote locations. In a third example, the activation of a tower-based fire suppression system can be based on several variable inputs. This system can protect tower components as well as exposed and enclosed systems on the ground.

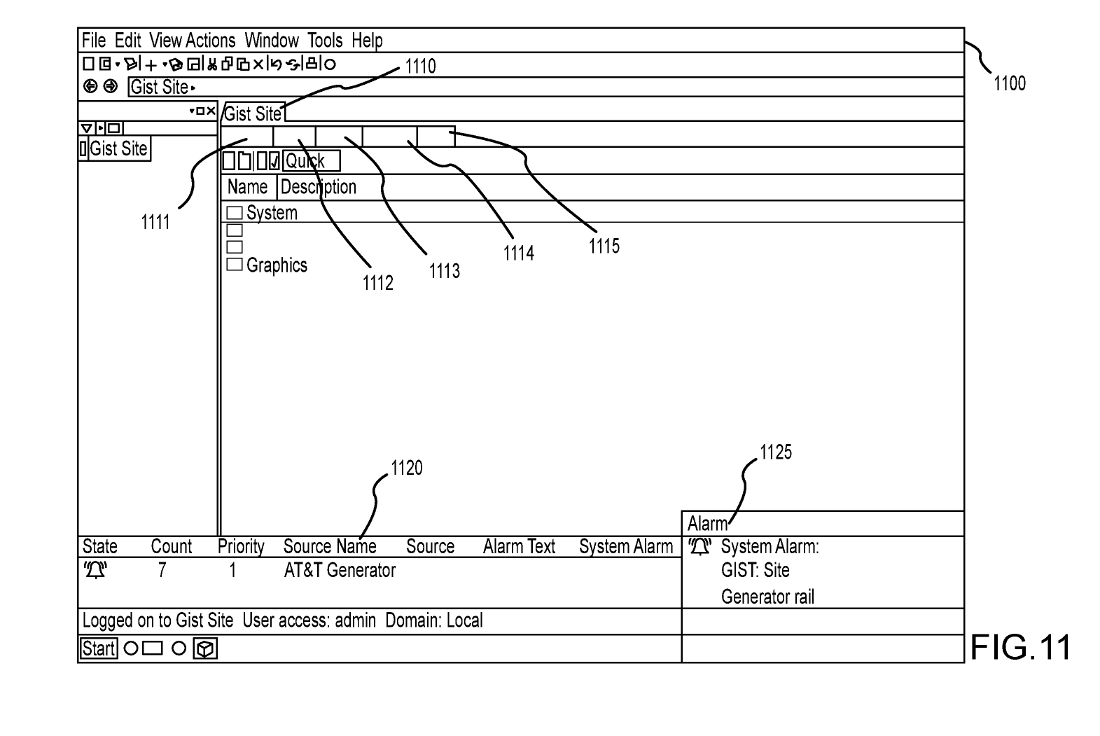

FIGS. 11-14 illustrate an embodiment of the operating system for the tower monitoring system as shown in sample “operating screens.” In general, the proprietary operating system for the tower monitoring system, the “operating system screens” (such as those referring to in FIGS. 11-14), generally allow the controller to monitor and adjust all of the I/O systems, as well as naturally lead to another series of screens. Referring now to FIG. 11 a site operation control screen 1100 is shown. FIG. 11 illustrates a menu that is based on the tower site. A tower site menu 1110 allows the controller to select from any number of views 1111-1115. A sample alarm 1120 is shown in the lower right corner along with an alarm box 1125.

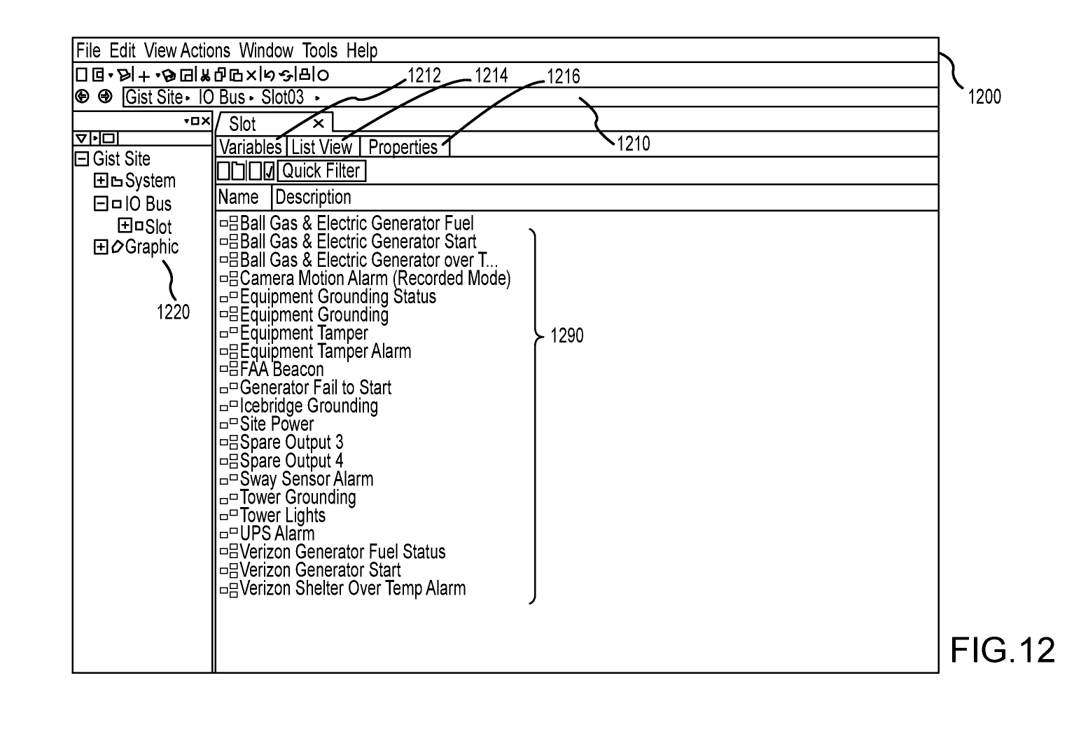

FIG. 12 illustrates an operation menu screen 1200. In the operation menu screen (shown in list view 1214) an operator can choose from among the inputs and outputs shown in the list 1250. An operator may also choose variable view 1212 and property view 1216. A system tree 1220 is shown at the left of the operation menu screen 1200.

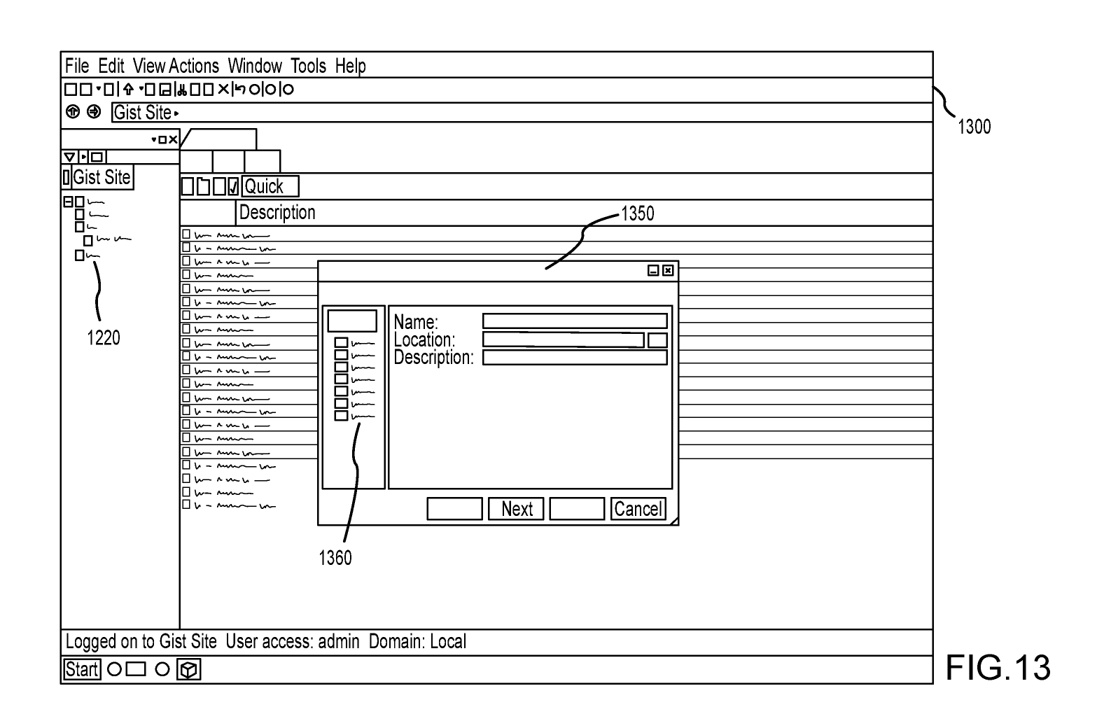

FIG. 13 illustrates an object creation screen 1300. An I/O object is created from the operation menu screen 1200. The I/O object may be any of the modules discussed above in FIG. 2A et seq. The object screen 1350 allows a controller to choose the type of I/O 1360, so that it may be added to the list 1250. FIG. 14 shows a security motion detection threshold screen 1400.

The above equipment and methods and modules will be supported by a software configuration adapted to the needs of the end user(s) and used to support the various platforms.

Although various embodiments and configurations have been illustrated and discussed above, they should not be considered to be limited to only the discussed illustrations. Rather, the scope of the applicant's claims should be considered by reference to the following claims.

1. A system for monitoring a communications tower including:
a) an enclosure for said monitoring system, said enclosure including a tower monitoring unit;
b) a power supply connected to said tower monitoring unit;
c) a set of analog inputs operatively connected to said tower monitoring unit;
d) a set of digital inputs operatively connected to said tower monitoring unit;
e) a module for connecting an external network to said tower monitoring unit;
f) said module for providing said set of analog inputs with at least one transponder, said transponder providing information regarding external environmental conditions to at least one dry or one digital input.

2. The system as recited in claim 1, further including a traffic monitoring module connected to one of said set of digital inputs.

3. The system as recited in claim 1, further including an equipment tamper switch operatively connected to one of said digital or said analog inputs.

4. The system as recited in claim 1, further including a backup battery monitoring system.

5. The system as recited in claim 1, further including an on-site camera operatively connected to one of said dry or digital inputs.

6. The system as recited in claim 1, wherein said tower monitoring unit comprises a programmed microcontroller.

7. The system as recited in claim 1, further including a module for detecting the twist and sway in the tower.

8. The system as recited in claim 7, wherein said twist and sway detecting module including a detector with a set of accelerometers.

9. The system as recited in claim 8, wherein said twist and sway detecting module is operatively connected to said system by a series of digital inputs.

10. The system as recited in claim 1, further including at least one thermistor input and at least one voltage input.

11. The system as recited in claim 8, wherein said twist and sway detecting module provides raw data to said tower monitoring unit.

12. The system as recited in claim 8, wherein said accelerometers are placed an optimal distance up the tower.

13. The system as recited in claim 1, wherein said power supply is 24 volts or less.

14. The system as recited in claim 1, further including a module for controlling and monitoring the tower lights.

15. The system as recited in claim 1, further including an air conditioning monitoring module.

16. The system as recited in claim 1, further including a ground monitoring unit.

17. The system as recited in claim 16, wherein said ground monitoring unit includes a reference ground.

18. The system as recited in claim 17, wherein said ground monitoring unit is coupled to a set of analog inputs.

19. The system as recited in claim 18, wherein said ground monitoring unit includes a set of ground monitoring units for individual carriers.

20. The system as recited in claim 16, further including a grounding alarm system.

21. The system as recited in claim 1 further including a generator monitoring module.

22. A tower monitoring system comprising:
a) an enclosure;
b) a power source;
c) a set of analog inputs;
d) a set of digital inputs;
e) a set of thermistor inputs
f) a set of voltage inputs;
g) a microcontroller connected to said dry inputs, said digital inputs and said environmental inputs;
h) a driver circuit for operating a series of relays;
wherein said microcontroller executes a set of instructions on a central processing unit to provide said data from said digital and analog inputs to an operating platform program, wherein said platform program executes instructions that provide said data from said digital and dry inputs to a graphic user interface.

23. A method for setting up a cellular tower monitoring system at a site, said system including a controller contained with an enclosure, said controller including a controller with a CPU connected to a data center via a network, including the steps of:
preloading information at a data center;
mounting and powering a site enclosure;
calling into data center and bringing said controller online;
confirming that the controller is online and ready for testing; and
running site testing, including the following tests:
i. testing a monitoring circuit;
ii. testing contact points;
iii. running through all contact points;
iv. running through all intrusion points; and
v. testing FAA lighting.

24. The method as recited in claim 23, further including tests on a generator.

25. The method as recited in claim 24, further including the following tests:
a. AC fail test;
b. remote generator start test;
c. fuel level test;
d. backhaul failure;
e. T1/T3 failure; and
f. Dark fiber test.
